(19) United States
(12) Patent Application Publication
(10) Pub. No.: US 2020/0317502 A1
(43) Pub. Date: Oct. 8, 2020

(54) Portable Fuel Storage Device with a Filtering System

(71) Applicant: Fuelie Systems, Inc., Lewes, DE (US)

(72) Inventor: Thomas R. Stumpf, Chapel Hill, NC (US)

(21) Appl. No.: 16/373,860

(22) Filed: Apr. 3, 2019

(51) Int. Cl. B67D 7/76; B60S 5/02; B67D 7/04; B67D 7/84; B67D 7/32

(52) U.S. Cl. CPC B67D 7/76; B60S 5/02; B67D 7/3272; B67D 7/845; B67D 7/04

(57) ABSTRACT

A portable fueling device that stores and filters fuel. The fueling device may include a frame configured to be towed by a towing vehicle. One or more transport members, such as wheels or skids, facilitate the movement. A fuel tank is positioned on the frame and a fuel line extends outward from the fuel tank. An end of the fuel line opposite from the frame can be configured to dispense the fuel. First and second filters are positioned along the fuel line and each is configured to remove contaminants from the fuel. The first filter is positioned upstream from the second filter and is able to filter smaller sized contaminants than the second filter. The first filter also has a larger capacity than the second filter. A pump can be positioned to move the fuel along the fuel line.

### BACKGROUND

Various fuel devices are known for storing and supplying fuel to a desired geographic location. One example includes a motorized vehicle with an attached fuel storage tank, such as a tanker truck. In use, the vehicle is loaded with fuel and then driven to the desired location where the fuel is dispensed. A similar example is a tank trailer that includes a fuel tank supported on a trailer platform and configured to be towed behind a vehicle.

Another portable fuel storage device is a fuel container sized to be handled by a user. The container includes an enclosed interior of usually less than a ten gallon fuel capacity and includes an exterior handle to facilitate movement. During use, the container is filled with fuel and then lifted and moved by the user to the desired location where fuel is dispensed.

Each of these various portable fuel storage devices has limited application.

### SUMMARY

One aspect is directed to a portable fueling device to store and transport fuel. The portable fueling device includes a frame with a hitch and one or more wheels or skids to be configured to be towed by a towing vehicle. A fuel tank is mounted to the frame and has an interior space to contain the fuel. A fuel line extends from the fuel tank and along the frame. A pump moves the fuel along the fuel line. First and second filters are positioned along the fuel line and each configured to remove contaminants from the fuel that is stored in the fuel tank. The first filter has a larger capacity than the second filter and is configured to remove smaller contaminants from the fuel than the second filter. The second filter is positioned along the fuel line downstream from the first filter and is further configured to remove water from the fuel.

In another aspect, the first filter is a one micron filter that is able to remove the contaminants as small as one micron and the second filter is a five micron filter that is able to remove the contaminants as small as five microns.

In another aspect, the first filter has a higher beta ratio than the second filter.

In another aspect, the second filter is a coalescing filter configured to remove the water from the fuel.

In another aspect, the pump is positioned along the fuel line and downstream from both the first filter and the second filter.

In another aspect, the fuel line includes a first end at the fuel tank and a second end downstream from the first and second filters and the pump with the second end having a dispenser to dispense the fuel.

In another aspect, one or more sensors are positioned downstream from the first filter and the second filter; and a control system includes a processing circuit and a communications interface circuit with the control system configured to receive signals from the one or more sensors and stop the fuel from being moved along the fuel line when a contaminant level is above a predetermined threshold.

One aspect is directed to a portable fueling device to store and transport fuel. The portable fueling device includes a frame with a hitch and wheels to be towed by a towing vehicle. A fuel tank is positioned on the frame and has an interior space to contain the fuel. A fuel line extends from the fuel tank. A pump moves the fuel along the fuel line. A first filter is positioned on the fuel line downstream from the fuel tank with the first filter having a first capacity and configured to remove a first size of contaminants from the fuel. A second filter is positioned on the fuel line downstream from the first filter with the second filter have a second capacity that is smaller than the first capacity and configured to remove a second size of the contaminants from the fuel. The second size is larger than the first size. The second filter is further configured to remove water from the fuel that passes through the first filter.

In another aspect, the first filter removes the contaminants as small as one micron from the fuel and the second filter removes the contaminants as small as five microns from the fuel.

In another aspect, the first filter has a higher beta ratio than the second filter.

In another aspect, the second filter is a coalescing filter configured to remove the water from the fuel.

In another aspect, the first filter is a particulate filter.

In another aspect, the pump is positioned along the fuel line and downstream from both the first filter and the second filter.

In another aspect, one or more sensors are positioned along the fuel line and the fuel tank; and a control system includes a processing circuit and a communications interface circuit and is configured to receive signals from the one or more sensors and prevent the fuel from being moved along the fuel line when a contaminant level in the fuel is above a predetermined threshold.

One aspect is directed to a method of transporting and filtering fuel with a portable fueling device. The method includes: attaching a hitch of fueling device to a towing vehicle with the fueling device comprising a frame and a fuel tank with fuel; transporting the fueling device to a geographic location; activating a fuel pump and moving the fuel from the fuel tank and along a fuel line of the fueling device; moving the fuel through a first filter and removing contaminants as small as one micron from the fuel; after moving the fuel through the first filter, moving the fuel through a second filter and removing the contaminants as small as five microns from the fuel and removing water from the fuel with the second filter having a smaller capacity; with the first filter having a greater capacity than the second filter to maintain a supply of the fuel at the second filter.

In another aspect, the method also includes moving the fuel through the fuel pump after moving the fuel through the first filter and the second filter.

In another aspect, the method also includes stopping the fuel pump when a contaminant level of the fuel downstream from the first filter and the second filter is above a predetermined threshold.

The various aspects of the various embodiments may be used alone or in any combination, as is desired.

### BRIEF DESCRIPTION OF THE DRAWINGS

FIG. 1 is a schematic diagram of a fueling device.

FIG. 2 is a perspective view of a fueling device.

FIG. 3 is a schematic diagram of a fuel system.

FIG. 4 is a schematic diagram of a control system.

FIG. 5 is a flowchart diagram of a method of filtering fuel.

FIG. 6 is a flowchart diagram of a method of filtering fuel.

FIG. 7 is a schematic diagram of a fuel system.

FIG. 8 is a schematic diagram of a fuel system.

### DETAILED DESCRIPTION

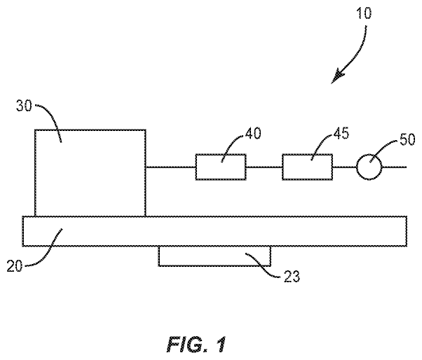

The present application is directed to a portable fueling device that stores and filters fuel. As illustrated in FIG. 1, the fueling device 10 includes a frame 20 configured to be towed by a towing vehicle. One or more transport members 23, such as wheels or skids, can be positioned to facilitate the movement. A fuel tank 30 is positioned on the frame 30. A fuel line 31 extends outward from the fuel tank 30. An end of the fuel line 31 opposite from the frame 30 can be configured to dispense the fuel. First and second filters 40, 45 are positioned along the fuel line 31 and each is configured to remove contaminants from the fuel. The first filter 40 is positioned upstream from the second filter 45. The first filter 40 is able to filter smaller sized contaminants than the second filter 45. The first filter 40 also has a larger capacity than the second filter. A pump 50 can be positioned to move the fuel along the fuel line 31.

The fueling device 10 can store and filter a variety of different fuels. One type of fuel is diesel fuel. The fuel may be used in Tier 4 compliant engines and need highly-filtered fuel with reduced amounts of contaminants. Another type of fuel is jet fuel for use in aircraft powered by gas-turbine engines. This can include Jet A and Jet A-1. The fueling device 10 can also be used to store and filter gasoline.

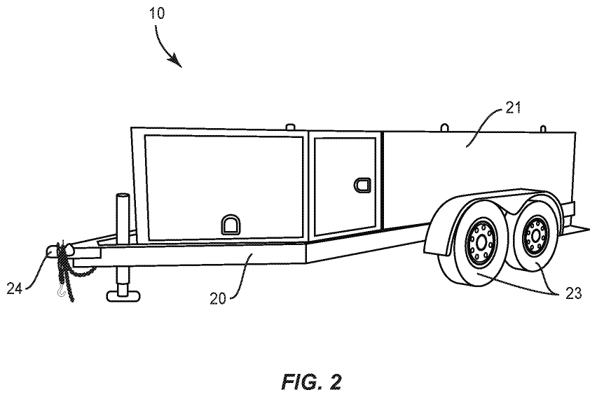

FIG. 2 illustrates a fuel trailer which is one type of fueling device 10. The fueling device 10 includes a frame 20 that supports the fuel components and an exterior body 21 that extends around the fuel components. The fueling device 10 includes one or transport member 23 for transportation. In this design, the transport members 23 include wheels 23 that can be mounted to one or more axles or suspension members on the underside of the frame 20. A hitch 24 can be positioned on the frame 20 for pulling the fueling device 10 behind a vehicle.

A similar fueling device 10 includes a sled that is similar to the fuel trailer disclosed in FIG. 2. The sled includes one or more transport members 23 that can include one or more skids attached to the underside of the frame 20. The sled is configured to slide across a surface, such as snow or rough terrain, while being pulled by vehicle. In some designs, a sled is able to be moved into rougher terrain than a wheeled trailer.

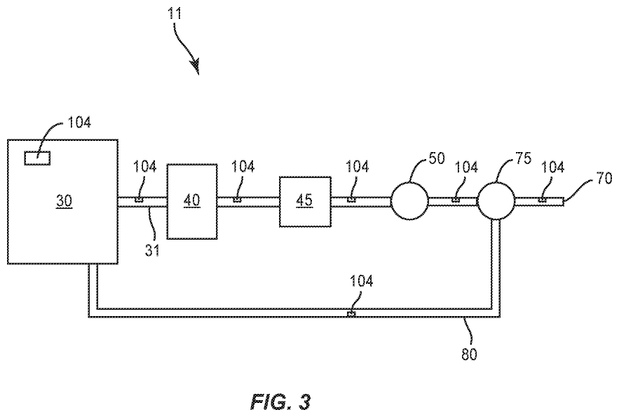

FIG. 3 illustrates schematically the fuel components of a fuel system 11 of the fueling device 10. A fuel tank 30 is configured to contain fuel that can be dispensed by the fueling device 10. The fuel tank 30 can include a variety of sizes depending upon the context of use. In one aspect, the fuel tank 30 is sized such that the fueling device 10 can be pulled by a vehicle without requiring a Commercial Driver License. A fuel line 31 extends from the fuel tank 30. The fuel line 31 can include various lengths and sizes.

A first filter 40 and a second filter 45 are positioned along the fuel line 31 to remove contaminants from the fuel. The first filter 40 is positioned along the fuel line 31 upstream from the second filter 45.

Both of the first and second filters 40, 45 filter contaminants from the fuel. The first filter 40 is able to filter smaller contaminants than the second filter 45. In one example, the first filter 40 can filter contaminants as small as one micron and the second filter can filter contaminants as small as five microns. The first and second filters 40, 45 can remove various contaminants, including but not limited to scale, mud, and debris.

In addition to removing contaminants, the second filter 45 also removes water from the fuel. This is particularly applicable for diesel fuel as water builds up in the fuel due to a variety of different reasons, such as heating and cooling cycles, and exposure of the diesel fuel to oxygen in the air. In one design, the second filter 45 is a coalescing filter that is able to reduce both contaminants and water from the fuel.

A pump 50 is positioned along the fuel line 31 to move the fuel through the first and second filters 40, 45. The one or more pumps 50 can move the fuel through the fuel line 31 at various rates. The one or more pumps 50 can have set rates, or can provide for variable fuel flow rates.

The first filter 40 has a higher capacity than the second filter 45. That is, the first filter 40 is able to filter a greater volume of fuel at a given fuel rate than the second filter 45. Thus, any reduction in the capacity of the first filter 40 caused by the greater filtering (due to the filtering of smaller contaminants) is compensated for by the larger capacity. Likewise, the smaller capacity of the second filter 45 is compensated by the relatively lesser filters (due to filtering of larger contaminants). Thus, the throughput of each of the first and second filters 40, 45 is roughly equal. This equality can provide less strain on the pump 50.

In one design, the first filter 40 includes a higher beta ratio than the second filter 45. The beta ratio is the effectiveness of a filter in removing contaminants of greater than a certain micron size. For example, the first filter 40 can be more effective in removing contaminants of greater than one micron.

After moving through the filters 40, 45, the fuel can be output through a dispensing end 70 that can be equipped with a hose and nozzle. The fuel can also be directed by a valve 75 through a line 80 and back into the tank 30.

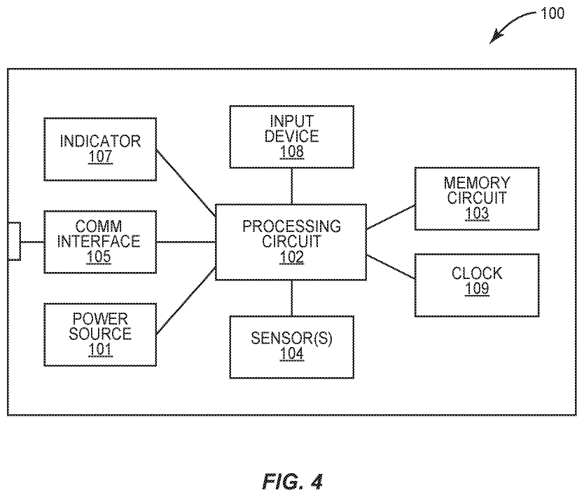

A control system 100 oversees the movement of fuel through the fuel system 11. As illustrated in FIG. 4, the control system 100 includes a processing circuit 102 that is communicatively coupled to one or more other components of the fueling device 10, e.g., via one or more buses. The processing circuit 102 can include one or more general-purpose and/or dedicated processors, including (but not limited to) one or more microprocessors, microcontrollers, application-specific integrated circuits (ASICs), field-programmable gate arrays (FPGAs), digital signal processors (DSPs), and/or other circuitry configured with appropriate software and/or firmware to control the movement of the fuel through the fueling device 10 according to program instructions stored in a memory circuit 103. The memory circuit 103 stores processing logic, programming code, and operational information for use by the processing circuit 102. The memory circuit 103 can include volatile memory, non-volatile memory, or both, according to various embodiments. One or more sensors 104 are positioned within the fueling device 10 and are configured to determine aspects about the fuel and/or the fuel system 11.

A communication interface 105 is configured to exchange signals with one or more remote sources. For example, the communication interface 105 can comprise an electronic transmitter for transmitting radio, electrical, and/or optical signals, and can further comprise an electronic receiver for receiving radio, electrical, and/or optical signals. In some embodiments, the communication interface 105 is configured to support short-range wireless signaling via BLUETOOTH, RFID, ZIGBEE, and/or WIFI. The communication interface 105 can additionally or alternatively be configured to support long-range wireless communication via cellular- and/or satellite-based signaling. The communication interface 105 can additionally or alternatively be configured to support signaling over a wired connection, such as a serial, USB, micro USB, FIREWIRE, Lightning, and/or Thunderbolt connection. There can be more than one communications interface 105. In such embodiments that support radio communication, an antenna (not illustrated) can be configured for the transmitting and receiving of wireless signals to and from the remote sources.

A clock 109 is configured to measure various timing aspects of the fuel in the fuel system 11. The control system 100 can further include one or more indicators 107, such as light-emitting diodes (LEDs) or LCD displays, for indicating various data items to a user. For example, the indicator 107 could be used to indicate the amount of fuel within the tank 30, the amount of time since the last re-polishing event, etc. An input device 108 such as a keypad, touchpad, switch, dial, buttons, track-ball, etc. can be included to receive inputs from an operator. The control system 100 can include a separate power source 101 such as a battery for powering one or more of the components. The control system 100 can additionally or alternatively receive power from an external source. In one design, the fueling device 10 is equipped with solar power capability that includes one or more solar panels that convert light energy. The power can be harnessed and used to operate one or more components of the control system 100 and/or the fuel system 11.

The sensors 104 can be positioned at various locations throughout the fuel system 11. The sensors 104 can detect various aspects of the fuel and/or fuel system 11, including but not limited to the flow rate, amount of fuel in the tank 30, status of one or more of the filters 40, 45 and contaminants in the fuel. Signals from the sensors 104 are received by the processing circuit 102 that calculates the various values. One or more of the sensors 104 can also detect environmental conditions of the environment and/or the fuel. This can be used by the processing circuit 102 to determine fuel status. Detected aspects include but are not limited to the temperature at the fueling device 10, the temperature within the fuel tank 30, the temperature of the fuel at one or more locations along the fuel system 11, and the humidity at the fueling device 10.

In one design, one or more of the sensors 104 positioned downstream from the first and second filters 40, 45 detect an amount of contaminants in the fuel. In the event the contaminants are above a predetermined threshold, the control system 100 can shut down the fueling system 11 and prevent dispensing of fuel.

In another design, one or more sensors 104 downstream from the second filter 45 detect an amount of water in the fuel. In the event the amount of water is above a predetermined threshold, the control system 100 can shut down the fueling system 11 and prevent dispensing of fuel.

The processing circuit 102 can polish the fuel in the event the fuel has been stored within the tank 30 for an extended period of time. For example, this can occur when the fueling device 10 is positioned at a remote location such as a remote outpost in which the demand for fuel is low. Another example is when the fueling device 10 is filled with fuel and positioned in preparation for an event (but not yet in use), such as for emergency management scheduling. One specific example is a fueling device 10 that stores fuel and is positioned in the field in anticipation of a possible hurricane strike. Another example is a fueling device 10 with fuel that is housed at a relatively remote airport that does not see regular air traffic.

The fueling device 10 can be configured to periodically move the fuel through the fuel system 11. This maintains the fuel in a usable state for when it is needed. The fueling device 10 can move the fuel on a regular basis (e.g., every day, every week), after the fuel temperature has been elevated above a predetermined threshold, as well as immediately before a fueling event.

In one design, the processing circuit 102 receives signals from the one or more sensors 104. When the amount of contaminants in the fuel downstream from the filters 40, 45 is below a predetermined threshold, the processing circuit 102 provides for fuel to be continued to be moved along the fuel line 31. If the contaminants are at or above the predetermined threshold, the processing circuit 102 can stop the flow of fuel. This prevents potentially damaging fuel from being dispensed.

In another design, one or more sensors 104 are positioned downstream from each of the filters 40, 45. The one or more sensors 104 detect the contaminants in the fuel after moving through each filter 40, 45. The processing circuit 102 receives signals from the one or more sensors 104 and is able to detect if just one or both filters 40, 45 are not adequately filtering the fuel. The processing circuit 102 can provide an indication to a technician or otherwise signal which one or both filters 40, 45 are in need of servicing and/or replacing.

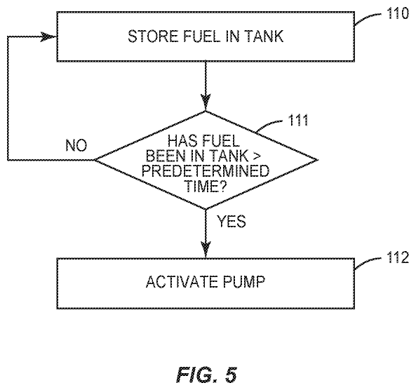

FIG. 5 illustrates a method of moving fuel through the fuel system 11. Initially, the fuel is stored in the tank 30 (block 110). The processing circuit 102 monitors the length of time that the fuel has been in the tank 30 and determines whether it exceeds a predetermined threshold (block 111). The threshold can vary depending upon different factors. In one embodiment, the threshold becomes smaller relative to the amount of time that the fuel has been stored in the tank 30 (i.e., a longer threshold when the fuel is originally stored in the tank 30, and a smaller threshold after the fuel has been in the tank 30 for a period of time). The time can also depend upon environmental conditions. For example, elevated temperatures at the fueling device 10 and/or of the fuel can result in more frequent fuel movement through the fuel system 11. When the processing circuit 102 determines the length of time exceeds the threshold, the processing circuit 102 activates the pumps P and moves the fuel through the fuel system 11. The valve 75 downstream from the filters is positioned such that the fuel that has been moved and filtered through the system 11 is returned via the return line 80 to the tank 30. One or more sensors 104 along the fuel system 11 detect the amount of fuel and/or flow rate of the fuel moving through the fuel system 11. The processing circuit 102 receives the signals and determines how long to move the fuel through the system. Moving the fuel through the fuel line removes impurities from the fuel and maintains the fuel in a useful condition such that the fuel is ready to be dispensed when necessary. The processing circuit 102 can be configured to periodically move a predetermined amount of fuel through the fueling system 11. The processing circuit 102 can also be configured to move the fuel through the fuel system 11 until one or more sensor readings indicate that the fuel is in a predetermined condition.

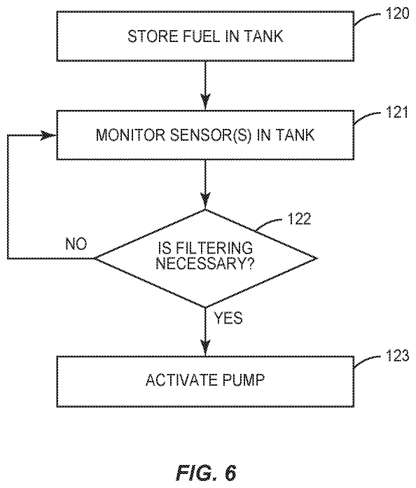

FIG. 6 illustrates another method of moving fuel through the fuel system 11. The fuel is initially stored in the tank 30 (block 120). One or more sensors 104 in the tank 30 detect the condition of the fuel (block 121). This can include detecting a variety of different aspects, including but not limited to water and/or contaminants in the fuel, and the temperature of the fuel. Monitoring of the fuel can be continuously performed, or can be performed on an intermittent basis. When the processing circuit 102 determines that one or more of the monitored aspects indicate that the fuel requires filtering (block 122), the processing circuit 102 activates the pumps P and moves the fuel through the fuel system 11 (block 123). This determination can include but is not limited the fuel having more than a predetermined amount of contaminants and the fuel temperature being above a predetermined threshold. After moving through the fuel system 11, the fuel is directed at the valve 75 into the return line 80 and moved back into the tank 30.

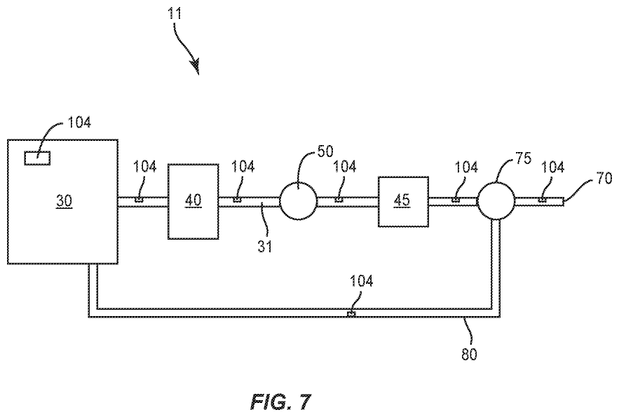

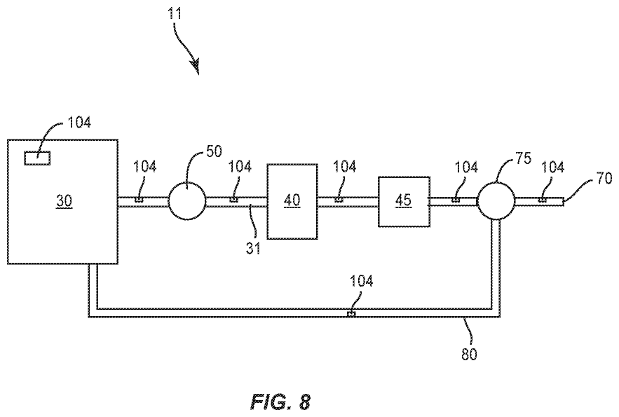

The location of the one or more pumps 50 relative to the filters 40, 45 can vary. FIG. 3 includes one design with the pump 50 positioned downstream from both filters 40, 45. FIG. 7 includes the pump 50 positioned between the filters 40, 45. FIG. 8 includes the pump 50 positioned upstream from the filters 40, 45. In each of the designs, the larger filter 40 is positioned upstream from the smaller filter 45.

A fueling device and filtering system is disclosed in PCT/US2018/054091 filed on Oct. 3, 2018, and hereby incorporated by reference in its entirety.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention can be carried out in other specific ways than those herein set forth without departing from the scope and essential characteristics of the invention. The present embodiments are, therefore, to be considered in all respects as illustrative and not restrictive.

What is claimed is:

1. A portable fueling device to store and transport fuel, the portable fueling device comprising:
a frame with a hitch and one or more wheels or skids to be configured to be towed by a towing vehicle;
a fuel tank mounted to the frame, the fuel tank having an interior space to contain the fuel;
a fuel line that extends from the fuel tank and along the frame;
a pump to move the fuel along the fuel line;
first and second filters positioned along the fuel line and each configured to remove contaminants from the fuel that is stored in the fuel tank;
the first filter having a larger capacity than the second filter and being configured to remove smaller contaminants from the fuel than the second filter; and
the second filter positioned along the fuel line downstream from the first filter and being further configured to remove water from the fuel.

2. The portable fueling device of claim 1, wherein the first filter is a one micron filter that is able to remove the contaminants as small as one micron and the second filter is a five micron filter that is able to remove the contaminants as small as five microns.

3. The portable fueling device of claim 1, wherein the first filter has a higher beta ratio than the second filter.

4. The portable fueling device of claim 1, wherein the second filter is a coalescing filter configured to remove the water from the fuel.

5. The portable fueling device of claim 1, wherein the pump is positioned along the fuel line and downstream from both the first filter and the second filter.

6. The portable fueling device of claim 1, wherein the fuel line comprises a first end at the fuel tank and a second end downstream from the first and second filters and the pump, the second end having a dispenser to dispense the fuel.

7. The portable fueling device of claim 1, further comprising:
one or more sensors positioned downstream from the first filter and the second filter; and
a control system comprising a processing circuit and a communications interface circuit, the control system configured to receive signals from the one or more sensors and stop the fuel from being moved along the fuel line when a contaminant level is above a predetermined threshold.

8. A portable fueling device to store and transport fuel, the portable fueling device comprising:
a frame with a hitch and wheels to be towed by a towing vehicle;
a fuel tank positioned on the frame, the fuel tank having an interior space to contain the fuel;
a fuel line that extends from the fuel tank;
a pump to move the fuel along the fuel line;
a first filter positioned on the fuel line downstream from the fuel tank, the first filter having a first capacity and configured to remove a first size of contaminants from the fuel;
a second filter positioned on the fuel line downstream from the first filter, the second filter have a second capacity that is smaller than the first capacity and configured to remove a second size of the contaminants from the fuel, with the second size being larger than the first size; and
the second filter being further configured to remove water from the fuel that passes through the first filter.

9. The portable fueling device of claim 8, wherein the first filter removes the contaminants as small as one micron from the fuel and the second filter removes the contaminants as small as five microns from the fuel.

10. The portable fueling device of claim 8, wherein the first filter has a higher beta ratio than the second filter.

11. The portable fueling device of claim 8, wherein the second filter is a coalescing filter configured to remove the water from the fuel.

12. The portable fueling device of claim 11, wherein the first filter is a particulate filter.

13. The portable fueling device of claim 8, wherein the pump is positioned along the fuel line and downstream from both the first filter and the second filter.

14. The portable fueling device of claim 8, further comprising:
one or more sensors positioned along the fuel line and the fuel tank; and
a control system comprising a processing circuit and a communications interface circuit, the control system configured to receive signals from the one or more sensors and prevent the fuel from being moved along the fuel line when a contaminant level in the fuel is above a predetermined threshold.

15. A method of transporting and filtering fuel with a portable fueling device, the method comprising:
attaching a hitch of fueling device to a towing vehicle, the fueling device comprising a frame and a fuel tank with fuel;
transporting the fueling device to a geographic location;
activating a fuel pump and moving the fuel from the fuel tank and along a fuel line of the fueling device;
moving the fuel through a first filter and removing contaminants as small as one micron from the fuel;
after moving the fuel through the first filter, moving the fuel through a second filter and removing the contaminants as small as five microns from the fuel and removing water from the fuel with the second filter having a smaller capacity;
the first filter having a greater capacity than the second filter to maintain a supply of the fuel at the second filter.

16. The method of claim 15, further comprising moving the fuel through the fuel pump after moving the fuel through the first filter and the second filter.

17. The method of claim 15, further comprising stopping the fuel pump when a contaminant level of the fuel downstream from the first filter and the second filter is above a predetermined threshold.
